(19) United States
(12) Patent Application Publication
(10) Pub. No.: US 2009/0212579 A1
(43) Pub. Date: Aug. 27, 2009

(54) Striker with damper

(76) Inventors: Todd Lawrence Hemingway, Metamora, MI (US); Walter Pipp, Birmingham, MI (US)

Correspondence Address: MCDONALD HOPKINS LLC, 600 Superior Avenue, East, Suite 2100, CLEVELAND, OH, 44114-2653, US

(21) Appl. No.: 12/316,225

(22) Filed: Dec. 10, 2008

Related U.S. Application Data
(60) Provisional application No. 61/005,972, filed on Dec. 10, 2007.

(51) Int. Cl. E05B 15/02

(52) U.S. Cl. 292/341.12; 292/341.14

(57) ABSTRACT

The present invention provides a striker with dampening features. The striker provides for improved noise and vibration control characteristics. The striker also reduces or eliminates chucking, squeak and rattle concerns in a door closure. The striker may include a base for mounting to a support structure, such as a vehicle. The striker may include a post capable of engaging the latch mechanism. The striker may also include a bridge that may extend between the back wall and the post. The striker may also have at least one protrusion located along a side of the bridge that is capable of engaging the latch mechanism. The striker may further include a wedge located adjacent the back wall and capable of wedged engagement with the fishmouth.

### CROSS-REFERENCE TO RELATED APPLICATIONS

This application claims benefit from U.S. Provisional Patent Application No. 61/005,972, entitled “Striker With Damper,” filed on Dec. 10, 2007, which is hereby incorporated in its entirety by reference.

### FIELD OF THE INVENTION

The present invention is generally related to strikers, and more particularly, to strikers with improved noise and vibration characteristics.

### BACKGROUND OF THE INVENTION

As is known in the art, many vehicles with doors, liftgates, or the like, have had issues with the rear end of the vehicle distorting as the vehicle runs over a rough road. This distortion causes significant deflection of the door relative to the door opening. This deflection is large enough for contact to be made between the door and the opening or at a high enough frequency that noise is emitted from the system. The present invention addresses this by providing a door latch striker to lessen this relative motion and eliminate the noise concerns.

A variety of latching mechanisms are known in the art and are used within the automotive industry for releasably coupling various movable components to the vehicle body. For example, latches are used for releasably coupling doors (e.g. passenger doors, liftgate, hood, trunk, etc.) to vehicles. The latching mechanisms are generally operable in a latched mode to secure the door to the vehicle body and in an unlatched mode where the door is freely movable relative to the vehicle body. The latching mechanisms typically include a latch that engages a striker when the door is in a closed position. The latch is typically secured near an edge of the door, and a striker is typically secured to the vehicle body.

Generally, only one edge of a door is releasably coupled to the vehicle body by way of one or more hinge mechanisms, or the like. A latch is typically mounted to the edge opposite the hinge mechanism. Also, the side edges of the door are generally not hinged or physically connected to the vehicle body. Therefore, motion of the vehicle can result in “match-boxing”, or non-parallel deflection of the vehicle body relative to the side edges of the door. This match-boxing is undesirable, in part, because it imparts additional vehicle noise, known as “chucking”, as the vehicle travels along rough or uneven surfaces.

Manufacturers often employ a variety of anti-chucking hardware to reduce the chucking resulting from match-box deflection. Common anti-chucking hardware includes wedges and spring-loaded bumpers that are positioned between the door edges and vehicle body such that some deflection load from the match-boxing is transferred to the door. Some latches may have a moveable wedge driven by a spring, where the wedge is designed to continually tighten against the striker to maintain zero clearance within the given gap. However, in some instances, the door dynamics and loading are so severe that the wedges and bumpers can be bounced out of position, thereby becoming completely ineffective. In addition, dirt and ice frequently compound this problem by further urging the wedges and/or bumpers out of position.

Another attempt at reducing chucking involves providing the fishmouth of the latch with features to reduce clearance between the striker bridge and fishmouth in order to control and minimize the relative motion between the striker and the latch. Typically, the interior walls of the fishmouth are provided with hard plastic flaps that are backed by an elastomeric material, which provides stiffness with compliance. The flaps may allow the housing to be more compliant while being more durable than just an elastomer. This allows the fishmouth to conform to the striker bridge to enhance the engagement between the striker and the latch. However, this system has proven to have limited effectiveness in the absence of corresponding protruding features included in the striker bridge.

Therefore, there exists a need in the art for a striker with improved noise and vibration control characteristics. The striker of the present invention is designed to reduce or eliminate chucking, squeak and rattle concerns in a door closure.

### DESCRIPTION OF THE DRAWINGS

Operation of the invention may be better understood by reference to the following detailed description taken in connection with the following illustrations, wherein:

FIG. 1 illustrates a perspective view of an embodiment of a striker.

FIG. 2 illustrates a second perspective view of the striker of FIG. 1.

FIG. 3 illustrates an environmental view of the striker of FIG. 1.

FIG. 4 illustrates a cross-sectional environmental view in accordance with FIG. 3.

FIG. 5 illustrates a second cross-sectional environmental view in accordance with FIG. 3.

FIG. 6 illustrates a perspective view of an alternative embodiment of a striker.

FIG. 7 illustrates a second perspective new of the striker of FIG. 6.

FIG. 8 illustrates an exploded perspective view of the striker of FIG. 6.

FIG. 9 illustrates an environmental view of the striker of FIG. 6.

FIG. 10 illustrates a cross-sectional environmental view in accordance with FIG. 9.

FIG. 11 illustrates a second cross-sectional environmental view in accordance with FIG. 9.

FIG. 12 illustrates a perspective view of an alternative embodiment of a striker.

FIG. 13 illustrates an exploded perspective view of the striker of FIG. 12.

FIG. 14 illustrates an environmental view of the striker of FIG. 12.

FIG. 15 illustrates a cross-sectional environmental view in accordance with Figure

FIG. 16 illustrates a second cross-sectional environmental view in accordance with FIG. 14.

### SUMMARY OF THE INVENTION

A striker for mounting to a support structure and for engagement with a latch mechanism having a fishmouth. The striker may include a base, a back wall and a post. The base may have at least one aperture for connecting the base to the support structure. The back wall may extend upwardly from the base and have an upper end. The post may extend upwardly from the base and have an upper end. The upper end of the post may be capable of engaging the latch mechanism.

The striker may also include a bridge that may extend between the upper end of the back wall and the upper end of the post. The striker may also have at least one protrusion located along a side of the bridge, wherein the protrusion is capable of wedged engagement with the fishmouth. Alternatively, the bridge and the post may be capable of wedged engagement with the fishmouth. The striker may further include a wedge located adjacent the back wall and capable of wedged engagement with the fishmouth.

A wedge may be capable of being connected to a striker. The wedge may include a base for connecting with the striker and at least one wedge connected to the base. The wedge may also include a pair of opposing wedge surfaces located on the wedge, wherein one surface may comprise a deformable elastomeric material and an opposite surface may comprise a rigid material.

### DETAILED DESCRIPTION

While the invention is described herein with reference to several embodiments, it should be clear that the invention should not be limited only to the embodiments disclosed or discussed. The description of the embodiments herein is illustrative of the invention and should not limit the scope of the invention as described or claimed.

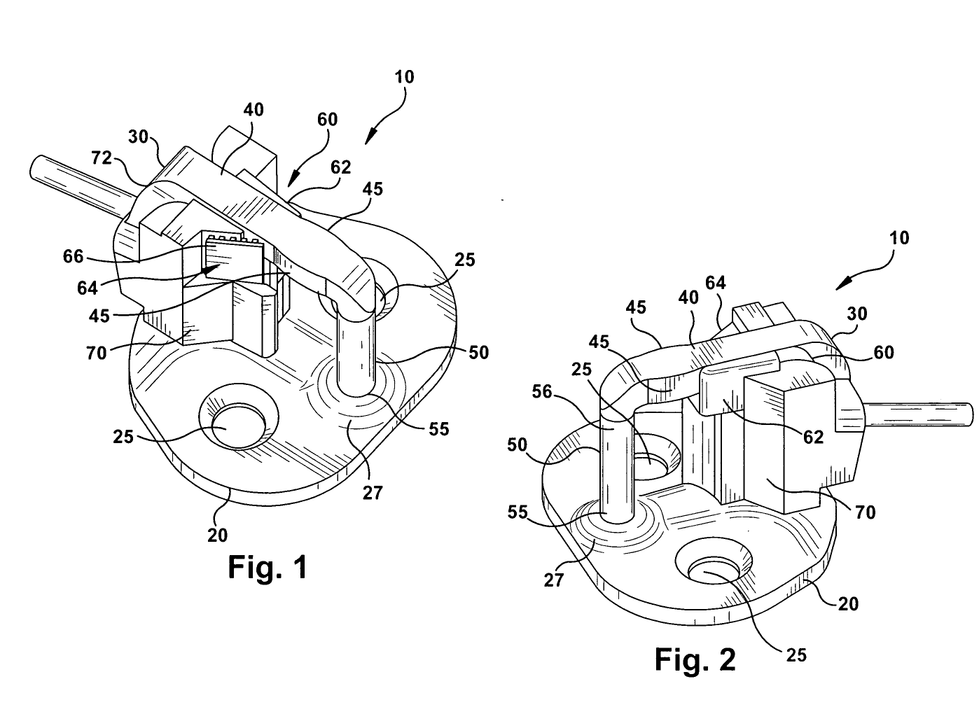

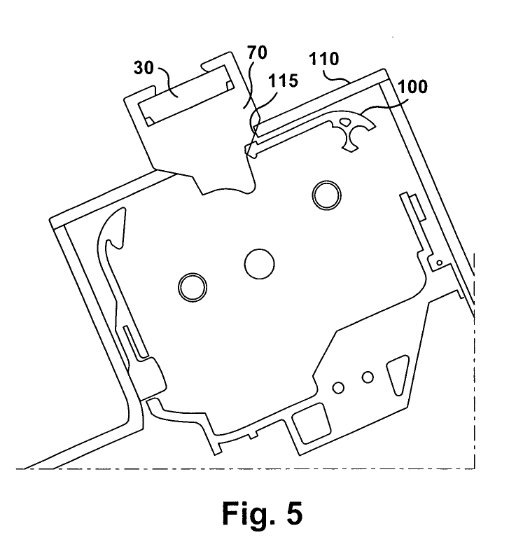

As generally described herein, the present invention provides a striker 10 with dampening features. Referring to FIGS. 1-5, a first embodiment of a striker 10 is shown. The striker 10 may include a base 20, which may serves as a mounting structure. Fasteners (not shown) may be passed or extended through apertures 25 to mount and secure the striker 10 to a surrounding structure. The surrounding structure may be, for example, a doorframe of an automobile body or the like. The base 20 may also include a boss 27. Extending from or otherwise attached to the base 20 may be a back wall 30 that may also serve as a structural feature of the striker 10. The back wall 30 may be utilized as an additional mounting structure or surface through which fasteners may be passed or extended to mount and secure the striker 10 to a body. The base 20 and back wall 30 may be formed from a single integral piece of material, such as steel or any other appropriate material. Alternatively, the base 20 and back wall 30 may be separate pieces that may be secured to one another by any appropriate means, including but not limited to welding, adhesive, mechanical fasteners, etc. and the like.

The striker 20 may further include a bridge 40 and a post 50. The post may include a first end 55 and a second end 56. The bridge 40 may extend from the back wall 30 to the second end 56 of the post 50. The bridge 40 may also include an additional material, such as steel or the like, to aid in guiding the door around the wedge like features. The post 50 may extend from the base 20 to the bridge 40. The bridge 40 and the post 50 may be formed from a single integral piece of material, such as steel or any other appropriate material. Alternatively, the bridge 40 and the post 50 may be separate pieces that are secured to one another by any appropriate means, including but not limited to welding, adhesive, mechanical fasteners, etc. and the like. The first end 55 of the post 50 may be fitted into or through the base 20. For example, the post 50 may be fitted through the boss 27 in the base 20 and secured thereto by any appropriate means, such as stamping, welding, mechanical fastening, adhesive and the like. As a further alternative, the base 20, the back wall 30, the bridge 40, and the post 50 may be formed from a single integral piece of material.

The exterior configuration of the post 50 between the base 20 and the bridge 40 may be of any appropriate shape or size, but is preferably of a cylindrical shape so that it may easily engage with the catch of a latch. It will be appreciated, however, that any other configuration or shape is possible, including but not limited to oblate, elliptical, spherical, square, rectangular, triangular, etc.

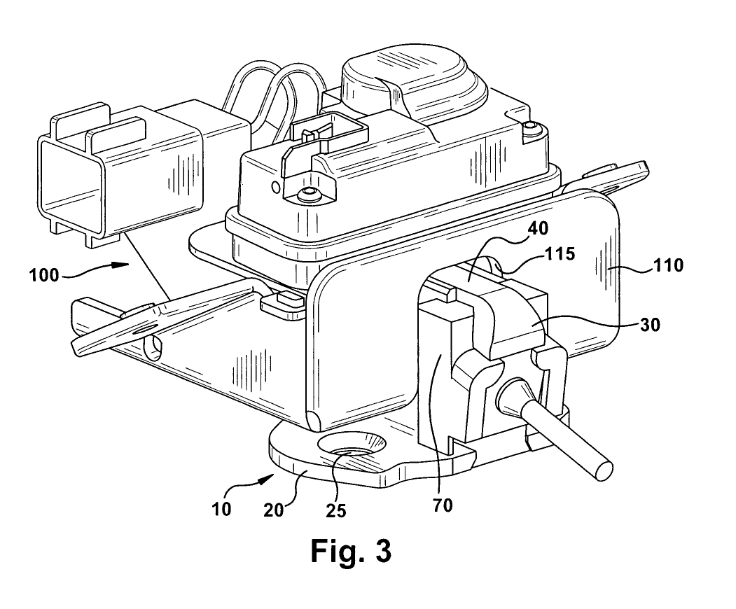

The bridge 40 may be connected to the back wall 30 by any appropriate means, including but not limited to welding, adhesive, mechanical fasteners, etc. and the like. However, it will be appreciated that the bridge 40 and the back wall 30 may be a single integral piece. In addition, either one or both sides of the bridge 40 may include a contoured profile or projection 45 that projects outward relative to the centerline of the bridge 40. When the striker 10 is fully engaged with a latch 100, as best seen in FIG. 3, the projection(s) 45 may exert pressure on a corresponding interior wall of the fishmouth 105. This engagement between the projection 45 and fishmouth 105 may reduce noise, vibration and chucking. U.S. patent application Ser. No. 11/732,351, which is herein incorporated by reference in its entirety, describes in further detail such bridge protrusions, various design options for such bridge protrusions and their mode(s) of operation.

The striker 10 may also include a wedge 60 and a bumper 70. The wedge 60 and the bumper 70 may be single integral piece or may be separate pieces that may be secured to one another by any appropriate means, including, but not limited to, sonic welding, adhesive, mechanical fastening, or the like. The wedge 60 may engage the fishmouth 105 of the latch 100 to thereby reduce lateral deflection of a vehicle door within a doorframe when the striker 10 and latch 100 are engaged. The wedge 60 may also include a rigid portion 62 and a pliable portion 64. As an alternative, the wedge 60 may include two rigid portions, two pliable portions, a single rigid portion, or a single pliable portion.

The striker 10 may have two sets of wedge bumpers. The first set of wedge bumpers 62, 64 that may or may not be built in. The rigid wedge bumper 62 may be designed to manage mostly side-to-side motion in the gate. This set has one rigid wedge bumper 62 that guides the striker 10 into the latch 100 while supporting the latch 100 and door from moving when the door is closed. The resilient or pliable wedge bumper 64 may be covered with a hard plastic, however it has a more forgiving elastic backing. This wedge 64 is designed to allow for easy closing of the gate while providing a high degree of side-to-side support to the door.

The second set of wedge bumpers 70 may be more symmetrical in design. Their surface may be elastomeric and more compliant than the first set of bumpers. The bumpers 70 may supply a balance of side to side and fore and aft support to the door relative to the gate. These bumpers 70 supply less side-to-side support to the door than the other bumpers 62, 64. These features supply an advantage over the existing technology in that the prior designs relied on the latch to supply an elastomer backed support feature. As an alternative, the striker 10 may include only the bumper(s) 70, the rigid wedge bumper(s) 62, or the pliable wedge bumper(s) 64, or any combination of the bumpers and wedge bumpers.

The striker 10 may be able to absorb vibration and reduce relative motion between the latch 100 and striker 10 and door and door opening. This reduction in relative motion eliminates contact between otherwise incompatible components in the door system reducing and eliminating objectionable noises.

The rigid portion 62 may be constructed from any appropriate material, such as plastic, metal, composite, etc. or the like. The rigid portion 62 may guide the striker 10 into the fishmouth 105 and bias the latch fishmouth 105 against the pliable portion 64 of the wedge 60.

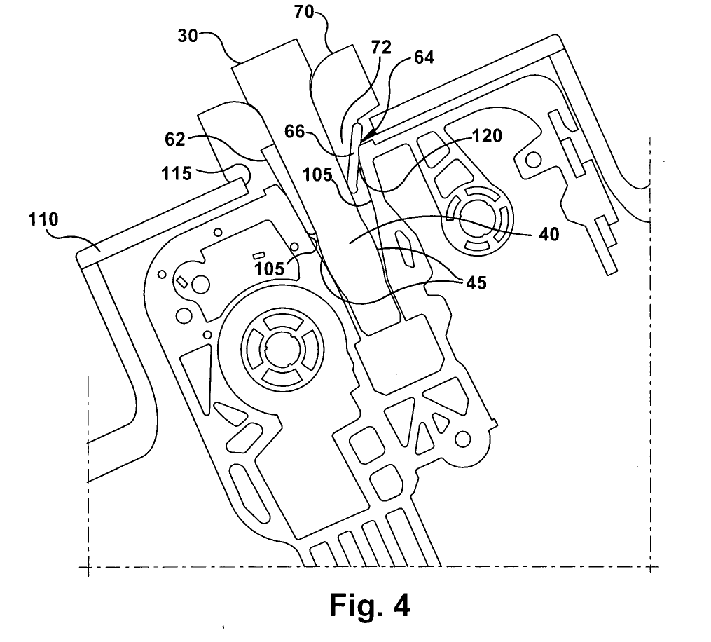

The pliable portion 64 of the wedge 60 may also include a resilient body 72 that may be constructed from any appropriate material, including, but not limited to, an elastomer or the like. As shown in FIG. 4, the resilient body 72 may be an integral portion of the bumper 70; however, it will be appreciated that the resilient body 72 may be completely separate body from the bumper 70. Alternatively, the pliable portion 64 may be constructed from a rigid material, such as a plastic or the like. The pliable portion 64 may also include interior voids or the like, so as to provide the pliable portion 64 with mechanically resilient properties. The pliable portion 64 may have a steeper angle as compared to the corresponding mating surface 120 of the fishmouth 105. The pliable portion 64 may partially conform to the mating surface 120 so that the fishmouth 105 may releasably engage the wedge 60 when the striker 10 and the latch 100 are engaged. The pliable portion 64 may also be operable to absorb vibration during vehicle travel as well as ensure suitable engagement between the striker 10 and the latch 100.

Additionally, the resilient body 72 may be encapsulated in or sandwiched between one or more rigid shells 66. The rigid shell 66 may include one or more openings (not shown) that may expose portions of the underlying resilient body 72 whereby the resilient body 72 may dampen sound during the closing of the door. In addition, the shell 66 may act as a friction plate while a automobile is moving along a road. For example, the resilient body 72 may be exposed through the openings to apply friction. Such exposure may direct door loads onto the striker 10 more effectively.

The bumper 70 may be secured to the striker 10 by any appropriate means, including, but not limited to, adhesive, mechanical fastening, or the like. The bumper 70 may be constructed from appropriate material, including but not limited to an elastomer or the like. The bumper 70 may be arranged to engage an aperture 115 in the latch support plate 110. In addition, the bumper 70 may engage a portion of the fishmouth 105. The bumper 70 may also absorb longitudinal and lateral vibrations or direct loads from the latch 100 to the striker 10.

In use, as best shown in FIGS. 3-5, the latch 100 may be introduced to the striker 10 whereby the post 50 and the bridge 40 enter the fishmouth 105 of the latch 100. As the fishmouth 105 moves towards the back wall 30 of the striker 10, the rigid portion 62 of the wedge 60 may urge the mating surface 120 of the fishmouth 105 against the pliable portion 64 of the wedge 60, whereby the latch 100 and the striker 10 are releasably engaged. In addition, the bumper 70 may be disposed within the aperture 115 of the latch support plate 110 and may also engage a portion of the fishmouth 105. Once the striker 10 and latch 100 are engaged, the wedge 60 and the bumper 70 may be operable to absorb and otherwise reduce noise and vibration due to door closure as well as vehicle travel.

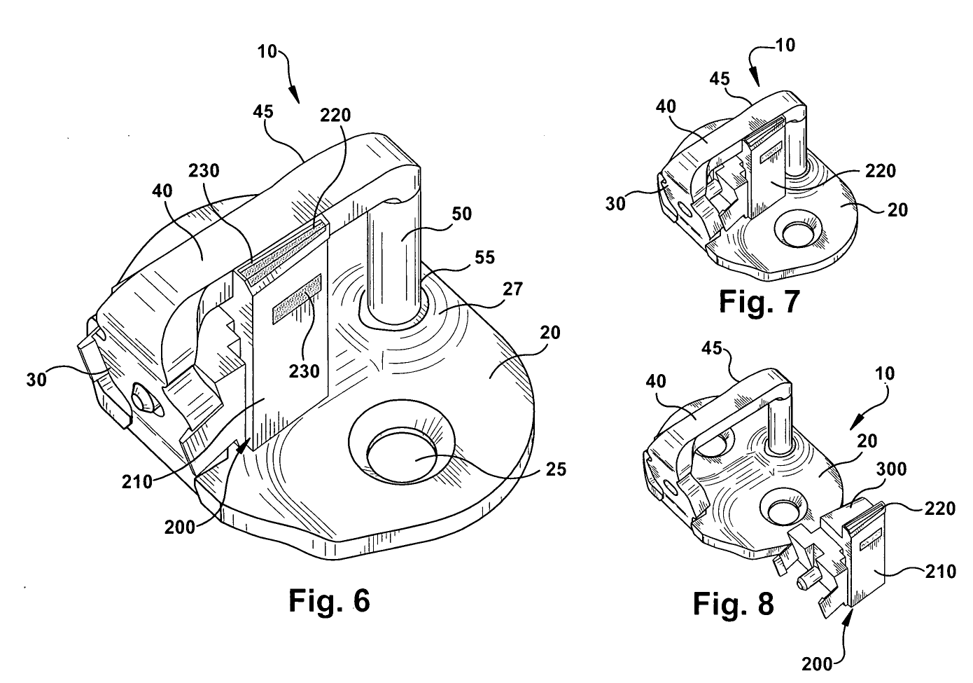

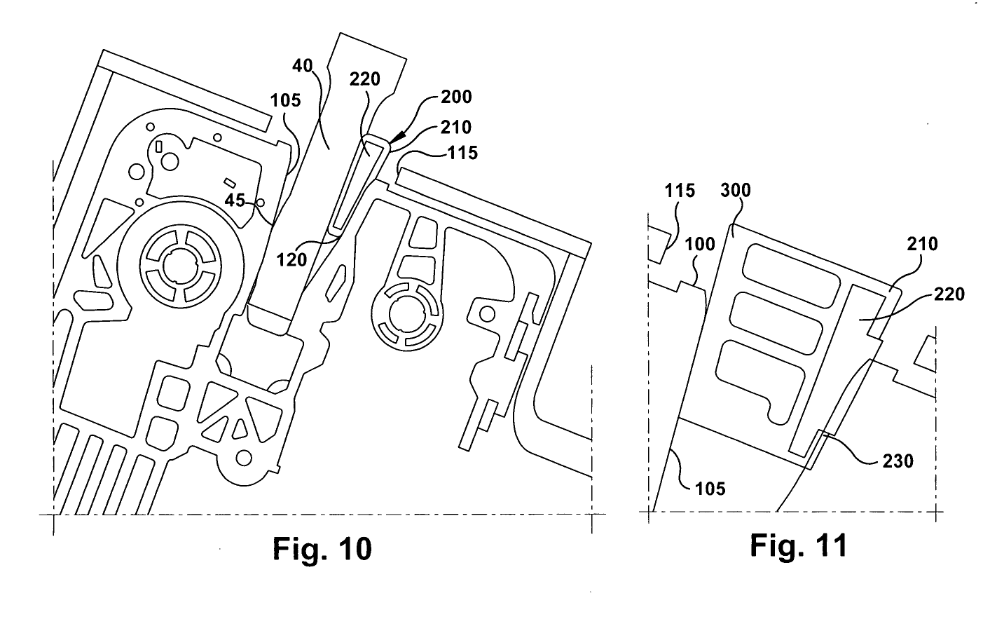

Referring now to FIGS. 6-11, a second embodiment of a striker 10 is shown. This embodiment is similar to that of the embodiment shown in FIGS. 1-5, so the prior element numbering, insofar as the base 20, back wall 30, bridge 40 and post 50 will be maintained. In this embodiment, the bridge 40 may include a protrusion 45 that projects outward relative to the centerline of the bridge 40.

In addition, the striker may include a pliable wedge 200 and a bumper 300. The wedge 200 and the bumper 300 may be integral or separate pieces that are secured to one another by any appropriate means, including, but not limited to, sonic welding, adhesive, mechanical fastening, or the like. The pliable wedge 200 may extend from the base 20 to the side of the bridge 40 located opposite to that of the protrusion 45. The pliable wedge 200 may include a rigid shell 210 that encompasses a resilient body 220. The rigid shell 210 may be constructed from any appropriate material, such as plastic, metal, composite, etc. or the like. The resilient body 220 may be constructed from any appropriate material, including, but not limited to, an elastomer or the like. Alternatively, it will be appreciated that the wedge 200 may be constructed entirely from a rigid and durable material, yet provided with interior voids and the like so as to provide the wedge 200 with mechanically resilient properties. The pliable wedge 200 may partially conform to the mating surface 120 such that the fishmouth 105 releasably engages the wedge 200 when the striker 10 and the latch 100 are engaged. Consequently, the pliable wedge 200 may absorb vibration during vehicle travel as well as ensure suitable engagement between the striker 10 and the latch 100.

Additionally, the shell 210 may include one or more openings 230 that expose portions of the resilient body 220. As previously discussed, the openings 230 may permit the resilient body 220 to dampen sound during door closing, as well as allow the resilient body 220 to apply friction that may direct door loads onto the striker more effectively.

The bumper 300 may be secured to the striker 10 by any appropriate means, including, but not limited to, adhesive, mechanical fastening, or the like. The bumper 300 may be constructed from any appropriate material, including, but not limited to, plastic, metal, composite, etc. or the like Alternatively, the bumper 300 may be constructed from a resilient material such as, for example, an elastomer or the like. In an embodiment, the shell 210 of the wedge 200 may be the same material as the bumper 300. While not shown in FIGS. 6-11, the bumper 300 may be arranged to engage an aperture 115 in the latch support plate 110. In addition, the bumper 300 may engage a portion of the fishmouth 105 of the latch 100. The bumper 300 may also absorb longitudinal and lateral vibrations. In addition, the bumper 300 may direct loads from the latch 100 to the striker 10.

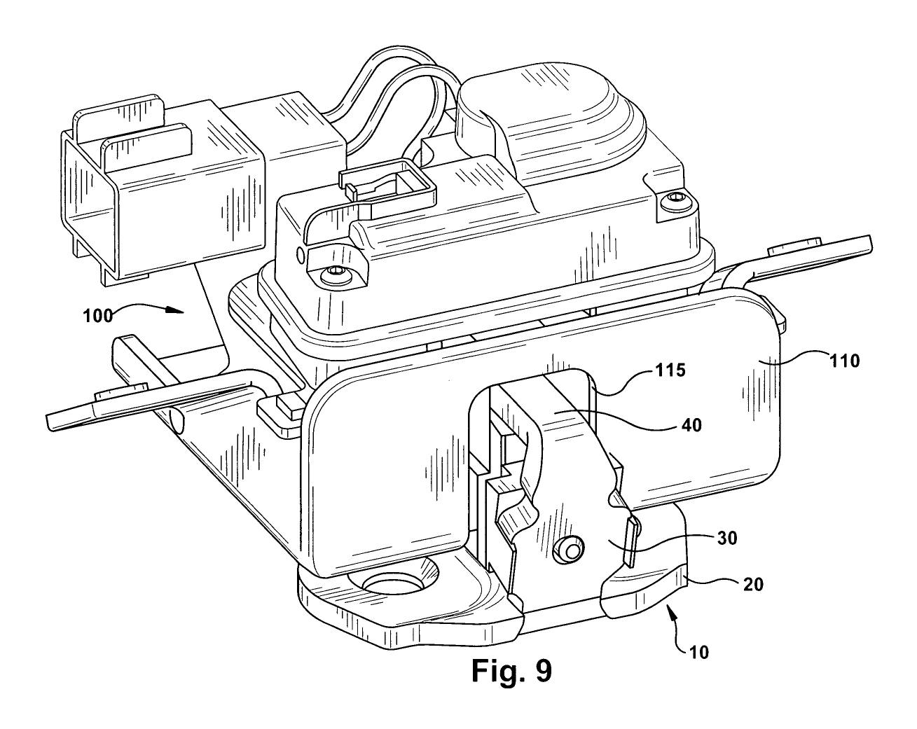

In use, as best shown in FIGS. 9-11, the latch 100 may be introduced to the striker 10 whereby the post 50 and the bridge 40 enter the fishmouth 105 of the latch 100. As the fishmouth 105 moves towards the back wall 30 of the striker 10, the protrusion 45 of the bridge 40 urges the mating surface 120 of the fishmouth 105 against the pliable wedge 200 whereby the latch 100 and the striker 10 are releasably engaged. In addition, the bumper 300 may be disposed within the aperture 115 of the latch support plate 110 and may also engage a portion of the fishmouth 105. Once the striker 10 and latch 100 are engaged, the wedge 200 and the bumper 300 may absorb and otherwise reduce noise and vibration due to door closure as well as vehicle travel.

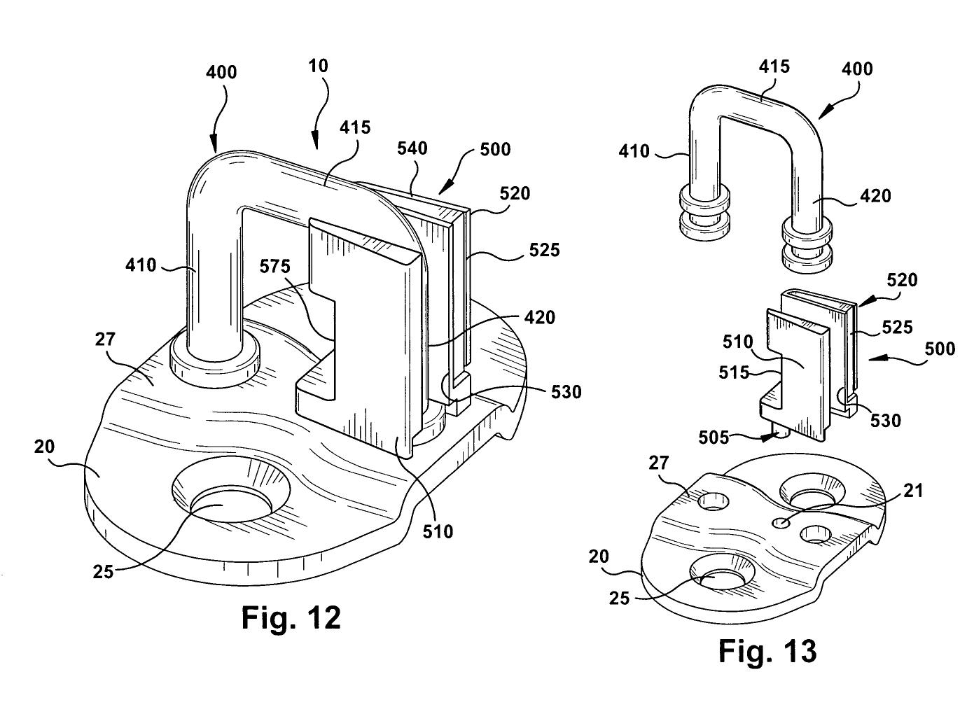

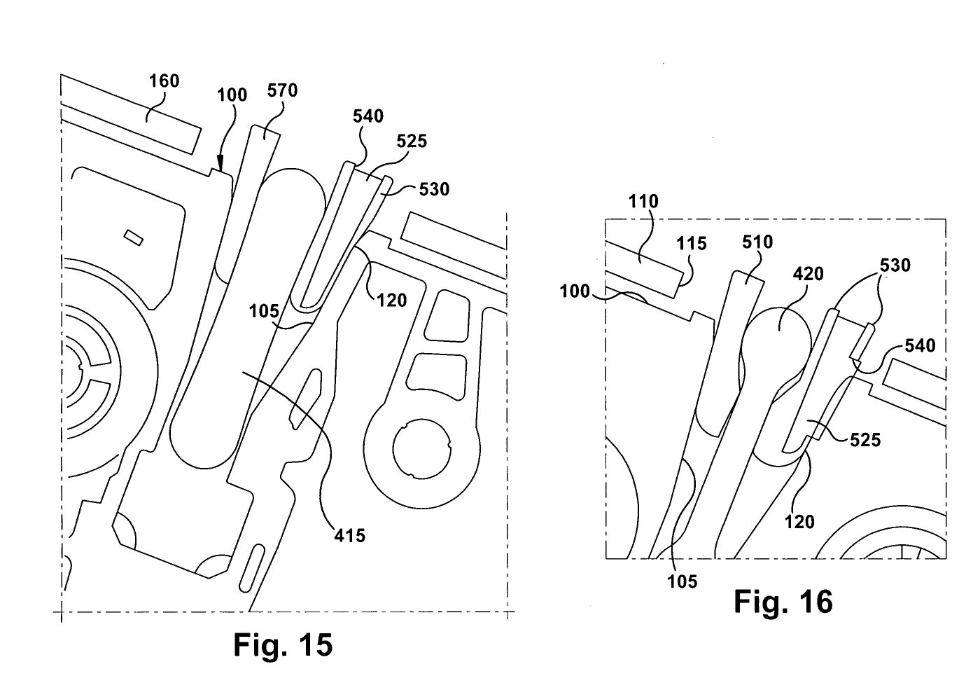

Referring to FIGS. 12-17, a third embodiment of a striker 10 is shown. In this embodiment, the post, the bridge and the back wall are replaced with a U-shaped bar 400. The U-shaped bar 400 may include a first leg 410, a second leg 420, and a bridge portion 415. The first leg 410 of the bar 400 may engage the fishmouth 105 and pawl (not shown) of the latch 100 and the second leg 420 may engage a wedge 500. The bridge portion 415 may be located between and interconnect the first and second legs 410, 420. The lower ends of the first and second legs 410, 420 may be secured to the base 20. For example, the legs 410, 420 may be fitted through a boss 27 in the base 20 and secured thereto by any appropriate means, including, but not limited to, stamping, welding, mechanical fastening, adhesive or the like. The U-shaped bar 400 may be of any appropriate size or shape but is preferably of a generally circular cross-section. It will be appreciated that any suitable cross-section shape may be employed, including, but not limited to, elliptical, square, rectangular, triangular, hexagonal, octagonal, etc.

The wedge 500 may be secured about the second leg 420. The wedge 500 may include a rigid wall 510 and a pliable wall 520. Alternatively, the wedge 500 may include two rigid walls, two pliable walls, a single rigid wall, or a single pliable wall. In addition, it will be understood that a bumper (not shown) as described above and similar to that of the first embodiment may also be secured about the second leg 420 and/or wedge 500.

A central bridge 515 may interconnect the rigid and pliable walls 510, 520. The rigid wall 510 may be constructed from any appropriate material such as plastic, metal or composite or the like. The rigid wall 510 may be operable to guide the striker 10 into the latch fishmouth 105 against the pliable wall 520.

The pliable wall 520 may include a resilient body 525 that may be constructed from any appropriate material, including, but not limited to, an elastomer or the like. The resilient body 525 may be sandwiched within a shell 530. Alternatively, the pliable wall 520 may be constructed from a rigid material, such as a plastic, but may also include interior voids so as to provide the pliable wall 520 with mechanically resilient properties. The pliable wall 520 may partially conform to the mating surface 120 of the fishmouth 105 such that the fishmouth 105 may releasably engage the wedge 500 when the striker 10 and the latch 100 are engaged. Consequently, the pliable wall 520 may be operable to absorb vibration during vehicle travel as well as ensure suitable engagement between the striker 10 and latch 100.

Additionally, the shell 530 may include one or more openings 540 that expose portions of the resilient body 525. As discussed above, the openings may permit the resilient body 525 to dampen sound during door closing, as well as allow the resilient body 520 to apply friction that may direct door loads onto the striker more effectively. Furthermore, the wedge 500 may also include a tab 505 that may be disposed within a corresponding aperture 21 in the base 20 to prevent rotation of the wedge 500 about the leg 420.

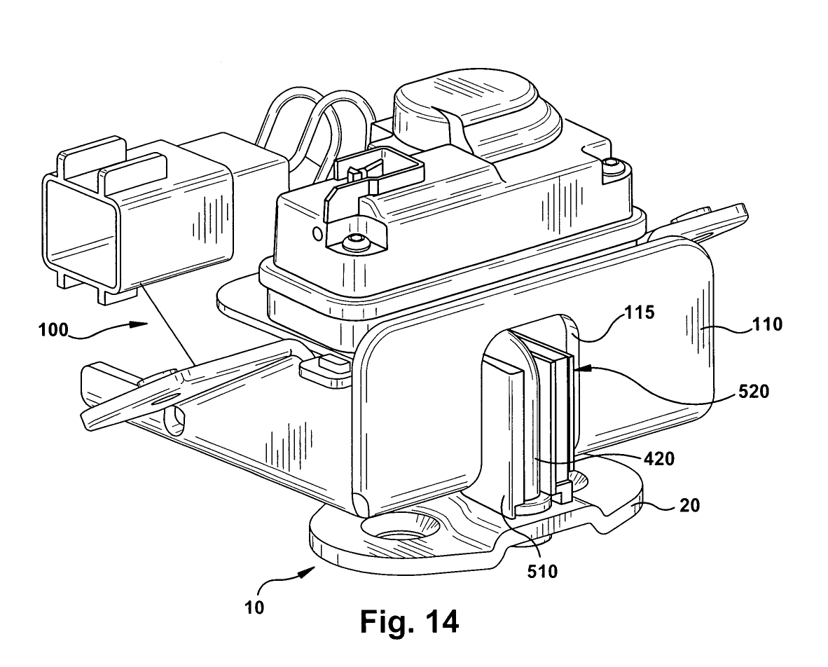

In use, as best shown in FIGS. 14-16, the latch 100 may be introduced to the striker 10 whereby the first leg 410 and the bridge portion 415 enter the fishmouth 105 of the latch 100. As the fishmouth 105 moves towards the second leg 420 of the striker 10, the rigid wall 510 may urge the mating surface 120 of the fishmouth 105 against the pliable wall 520, whereby the latch 100 and the striker 10 are releasably engaged. Once the striker 10 and the latch 100 are engaged, the wedge 500 may be operable to absorb and otherwise reduce noise and vibration due to door closure as well as vehicle travel.

The embodiments of the invention have been described above and, obviously, modifications and alternations will occur to others upon reading and understanding this specification. The claims as follows are intended to include all modifications and alterations insofar as they come within the scope of the claims or the equivalent thereof.

Having thus described the invention, we claim:

1. A striker for mounting to a support structure and for engagement with a latch mechanism having a fishmouth, said striker comprising:
a base having at least one aperture for connecting said base to the support structure;
a back wall extending upwardly from said base and having an upper end;
a post extending upwardly from said base and having an upper end, wherein said post is capable of engaging the latch mechanism;
a bridge extending between said upper end of said back wall and said upper end of said post;
at least one protrusion located along a side of said bridge, wherein said protrusion is capable of wedged engagement with the fishmouth; and
a wedge located adjacent said back wall and capable of wedged engagement with the fishmouth.

2. The striker of claim 1, wherein said bridge further includes at least one protrusion located along an opposite side of said bridge, wherein said at least one protrusion is capable of wedged engagement with the fishmouth.

3. The striker of claim 1, wherein said wedge is located along one side of said bridge.

4. The striker of claim 3 further comprising at least one wedge located along an opposite side of said bridge.

5. The striker of claim 1, wherein said wedge includes an engagement surface located on a side of said back wall.

6. The striker of claim 1, wherein said wedge includes an engagement surface located on opposing sides of said back wall.

7. The striker of claim 1 further comprising a second wedge located between said first wedge and said post.

8. The striker of claim 7, wherein said second wedge comprises a pliable material.

9. The striker of claim 7 further comprising a third wedge located between said first wedge and said post.

10. The striker of claim 9, wherein said third wedge comprises a rigid material.

11. The striker of claim 9, wherein said third wedge is capable of guiding said post into the fishmouth.

12. The striker of claim 1, wherein said wedge prevents side-to-side motion in the latch mechanism.

13. The striker of claim 1, wherein said back wall is integrally formed with said base.

14. The striker of claim 1, wherein said back wall is connected to said base.

15. The striker of claim 1, wherein said post is integrally formed with said base.

16. The striker of claim 1, wherein said post is connected to said base.

17. A striker for mounting to a support structure and for engagement with a latch mechanism having a fishmouth, said striker comprising:
a base having at least one aperture for connecting said base to the support structure;
a back wall extending upwardly from said base and having an upper end;
a post extending upwardly from said base and having an upper end, wherein said post is capable of engaging the latch mechanism;
a bridge extending between said upper end of said back wall and said upper end of said post, wherein said bridge and said post are capable of wedged engagement with the fishmouth; and
a wedge located adjacent said back wall and capable of wedged engagement with the fishmouth.

18. The striker of claim 17, wherein said wedge further includes at least one engagement surface located along either side of said back wall.

19. The striker of claim 18, wherein said engagement surface is either comprised of a rigid material or a pliable material.

20. A wedge capable of being connected to a striker, said wedge comprising:
a base for connection with the striker;
at least one wedge connected to said base;
a pair of opposing wedge surfaces located on said wedge, wherein one surface comprises a deformable elastomeric material and an opposite surface comprises a rigid material.
